(19) United States
(12) Patent Application Publication
(10) Pub. No.: US 2014/0034032 A1
(43) Pub. Date: Feb. 6, 2014

(54) SMART IGNITION COIL WITH INTEGRATED CONTROLLER

(71) Applicants: Massimo Augusto Dal Re, Modena (IT); Mauro Costa Bizzarri, Anzola dell Emilia (IT)

(72) Inventors: Massimo Augusto Dal Re, Modena (IT); Mauro Costa Bizzarri, Anzola dell Emilia (IT)

(21) Appl. No.: 13/985,038

(22) PCT Filed: Feb. 11, 2011
(86) PCT No.: PCT/EP2011/052056

§ 371 Date: Oct. 22, 2013

(51) Int. Cl. F02P 7/00

(52) U.S. Cl. CPC F02P 7/00
USPC 123/594

(57) ABSTRACT

Disclosed is a device comprising an ignition coil, a power stage and a controller connected to said ignition coil via said power stage. The controller is adapted to receive commands and/or parameters related to engine operation and to process said commands and/or parameters and the controller is further adapted to output a voltage signal to said ignition coil via said power stage, said signal being based at least in part on said processed commands and/or parameters.

### TECHNICAL FIELD

The invention is related to a method and device for controlling an ignition coil and, more particularly, to a smart ignition coil including such a device.

### BACKGROUND

Ignition systems in engines are usually controlled via mechanical or electronic elements. In both cases, ignition is achieved by a sudden break of the current flow in the first transformer winding of an ignition coil, which in turn leads to a rapidly collapsing magnetic field. The change in the magnetic field induces a high voltage in the secondary windings of the ignition coil. For mechanical solutions, current breakers are used for breaking the circuit, while in electronic solutions e.g. a transistor or thyristor is used for switching the transformer coil current. The high voltage at the second coil may also be distributed via a distributor to several spark plugs of an engine.

Ignition timing is crucial for the performance of an engine. Bad timing of the ignition sparks may impair engine performance or even damage parts of the engine. Angular sensors such as hall triggers are usually used for electronically synchronizing valve cycles and ignition timing Additional circuit elements may be implemented in an electronic ignition system for achieving a specific ignition timing behaviour, for example, advancing or retarding the timing as desired.

As an example, ramp generators may be used to provide a voltage signal of desired magnitude and pulse length in relation to engine speed.

However, all these features of an ignition system require a separate circuit element that is only adapted to a specific task. Optimizing the ignition system for an engine then requires providing engine specific, application specific hardware components. Changes to a set system are complex and elaborate.

There is thus a need for a flexible, low cost ignition coil control which allows using a single hardware solution in a wide variety of different setups and requirements. Such a solution is given by the device and the method recited in the claims.

### SUMMARY

Disclosed is a device comprising an ignition coil, a power stage and a controller connected to said ignition coil via said power stage. The controller is adapted to receive commands and/or parameters related to engine operation and to process said commands and/or parameters, and the controller is further adapted to output a voltage signal to said ignition coil via said power stage, said signal being based at least in part on said processed commands and/or parameters.

### BRIEF DESCRIPTION OF THE DRAWINGS

In the following, exemplary embodiments will be described in more detail, wherein

FIG. 1 shows a schematic circuit diagram of an exemplary ignition system, and

FIG. 2 shows a functional block diagram for an exemplary ignition system such as that of FIG. 1.

### DETAILED DESCRIPTION OF THE PREFERRED EMBODIMENTS

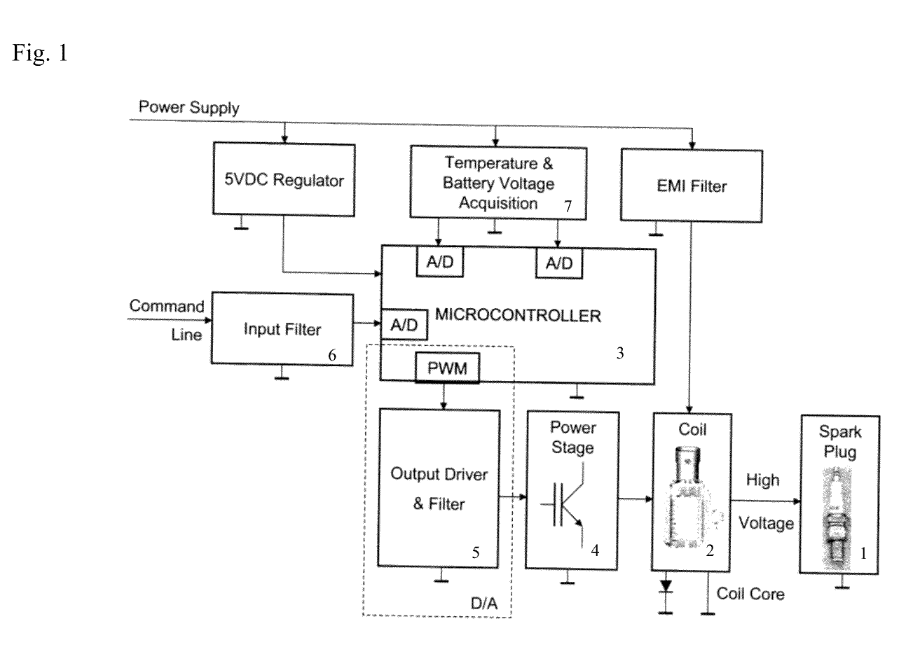

FIG. 1 is a schematic view of elements in an embodiment of the ignition system. An ignition coil 2 is shown which is used for providing a high voltage to a spark plug 1 in an engine setup. One coil of this type may be available for each spark plug in an engine, but may also be used for two or more spark plugs at a time, for example in a “wasted spark” setup. The coil 2 may be mounted remotely or directly onto the spark plug 1, and the coil 2 may in some embodiments also be included in a coil pack with the cylinders. As in common ignition systems, the ignition coil is driven by a voltage signal and transforms this signal to a high voltage signal to the spark plug 1 for igniting the spark.

The controller 3 shown in FIG. 1 is the main part of an intelligent ignition coil. This controller 3 may preferably be located in the coil package itself or is at least in connection with the ignition coil 2. When the microcontroller 3 is mounted directly on the coil 2, a single device solution is provided that requires minimum space and effort for installation at the spark plug.

With a programmable microcontroller or microprocessor 3, an ignition system may be flexibly adjusted to different operating conditions, different engine hardware, errors and any other desired parameter relevant for ignition. The microcontroller 3 may run application software that allows command line inputs and/or engine parameters before and during operation. When characteristics of the ignition system require a change, no hardware changes need to be made to the ignition circuit design or any other hardware; rather, the microcontroller firmware may be updated as needed or parameters fed to the microcontroller may be changed externally. By providing a dedicated coil controller 3 with each ignition coil 2 in an engine, a fine ignition management for each cylinder separately is achieved with a minimum number of discrete components. As there is no need for any additional circuit components for the ignition coil, a coil system with integrated controller logic requires less space and effort for installation, and the coils may easily be adapted to different conditions and engines.

Parameters that may be taken account by the application software of the microcontroller may be input directly via commands, may be transmitted from another controller such as an engine control unit (ECU) which is responsible for controlling the complete engine behaviour, or may be received from suitable sensors connected to the microcontroller.

The controller 3 may be provided with inputs for one or more of these data signals, and the inputs may optionally include an analog/digital converter for sampling analog data. As an example, engine temperature and battery voltage parameters may be received directly at the microcontroller 3. These values may be obtained from single or combined sensors 7 which are adapted for measuring and transmitting the parameters periodically or continually. The parameters may either be transmitted from the sensors to one or more controllers, e.g. to both engine control unit (not shown) and coil microcontroller 3, or may be transmitted to a single central controller which may relay the parameter values to other devices as necessary. An input filter may be optionally applied at any of the microcontroller inputs.

It will be understood that the parameters influencing the microcontroller output are not limited to temperature and battery voltage. Any parameter that is relevant for ignition control at all may be used in the corresponding application software of the microcontroller.

Further examples are combustion parameters, spark duration, spark frequency, misfiring detection, octane rating, knock behaviour, and others.

Between the coil and the microcontroller a power stage 4 is connected. The power stage may work like a primary circuit breaker. This power stage may be designed as generally known in the art and as such may include e.g. a power transistor. The power stage may be driven by an output driver stage 5 implementing a digital/analog converter (DAC) which receives the digital signal from the microcontroller 3 output. The output driver stage 5 may include an RC filter element which is fed by the pulse width modulated (PWM) signal from the microcontroller output. The RC element may low pass filter the PWM signal to extract the average voltage for driving the primary circuit breaker. In this way, the pulse width modulation output and the RC filter together form a D/A converter to generate a voltage ramp for the power stage 4, which may e.g. be implemented as an insulated gate bipolar transistor IBGT. In that case, the ramp voltage is supplied to the IGBT gate terminal in order to modulate the collector current. The microcontroller 3 may use a specific designed value resistor to achieve fast discharge of the capacitor and generate the spark. Alternatively, it would be possible to use a pair of bipolar junction transistors to fast charge/discharge the capacitor. Also, the microcontroller may include a full digital/analog converter itself instead of the pulse width modulated output together with the RC filter element. In both cases, the primary circuit breaker or power stage is fed with an analog signal voltage which is calculated by the microcontroller.

Using suitable control algorithms with the microcontroller 3, it may be possible to generate any voltage level and slope that is required to manage the coil primary current and secondary high voltage generation. In FIG. 1, it is shown that a pulse width modulated signal output from the microcontroller 3 is fed into an output driver and filter element 5 which then provides the converted analog voltage signal to the power stage 4. The power stage 4 is connected to the coil 2. It will be understood that in a combined coil/microcontroller package, the power stage 4 and output driver stage 5 will preferably be mounted on the coil 2 as well.

These and other electrical or electronic elements may be provided in the form of through-hole technology elements on printed circuit boards, of surface-mounted device (SMD) elements, or any desirable combination of these. SMD elements would allow an even smaller package design of the control elements on the coil.

Although coil 2, spark plug 1, microcontroller 3 and other elements are shown in the figure as separate elements, this is only to be understood as a schematic view of circuit connections. In practical implementations, the microcontroller and the further electronic components such as power stage and filter may be assembled on the coil directly and may optionally be combined with the spark plug in a single device. Such an embodiment would provide a single hardware solution which is capable of fitting many different requirements, such as different engines and different operating conditions. The embodiments described herein allow transferring the ignition related control tasks from the engine control unit or from static electronic designs to the dedicated ignition controller, thus presenting a “smart ignition coil” for various engine setups.

The software-based control of ignition features may also provide direct error control for the ignition process, either based on a feedback control loop which may use measurement values of the running engine for feedback, or via external commands and parameter inputs when errors are detected e.g. by another controller device. No hardware changes are necessary for optimal tuning of an engine or for special requirements, which may also be only temporary settings and may be reversed when conditions change.

All elements of the controller and connected devices may be suitably grounded and provided with power supplies, filters and connections where required. These elements are well known in the art and will not be described in detail, although examples may be shown in the figures. For example, an electromagnetic interference filter (EMI) may be used in between a power supply and the coil, and an input filter may be inserted at the command line input of the microcontroller. A regulator may be employed for providing the required voltage to the microcontroller, e.g. 5 V. Further common elements of an engine ignition system such as spark plug, cylinder and valve elements, or power supplies for sensors and controllers are well known in the art and will also not be discussed here in detail, but may of course be combined in any suitable way with the teachings provided herein.

The application software within the controller of FIG. 1 provides the output signal for the output driver. This output signal may be obtained by using preset algorithms with predetermined parameters. The algorithms and parameters may be stored in a storage module included in or connected to the microcontroller. Alternatively, at least a part of the parameters used in the algorithm(s) may be received at the microcontroller from another entity. Optionally, algorithms may be changed and/or replaced by commands received at the microcontroller, that is, in the form of a firmware update. In this way, coil controlling may be easily adapted to specific engine details, to desired operating characteristics or special conditions.

The application software may be split into several modules in the case of at least partially software based functions. Again, these modules may be exchangeable and may be customized via parameters, firmware updates and/or commands both before and during operation. They may also be combined with some hardware based functional modules. In some embodiments, a part of the software modules related to ignition control may be located at the local dedicated coil controller 3, while the remaining algorithms are executed at separate control entities such as the engine control unit ECU. Results and values obtained from the ECU may then be further processed at the coil controller, and data may also be transmitted back to the ECU. In other embodiments, any ignition related software application modules may be implemented within the coil controller 3. Alternatively, the application software of the microcontroller may be present in a single application.

The modules may include various elements that are usually implemented via hardware circuit solutions in prior art. For example, obtained sensor values may be compared with stored values for determining whether predefined threshold values are maintained during operation. Spark-free operation may be desired at certain times, for example in hybrid vehicles which rely on other sources of energy besides the combustion engine or which apply start-stop systems, and deactivating and activating the ignition system correctly may need to be controlled. Further elements that might be implemented via software modules in the microcontroller directly on the coil are ramp generators for generating a pulse width modulated signal with increasing or decreasing duty cycle in order to control the primary current slope and limit the secondary voltage; dwell measure related to the duration of the activation signal provided by the main engine control unit; or multi-spark generators for deciding on the number of sparks fired during a cycle and their timing. Any of these modules may use input signals received from other modules, signals produced by circuit blocks or sensors, and/or they may drive other modules and parts of the control system, such as a primary circuit breaker transistor. All these modules are only examples of common modules for ignition control, and they may be complemented or replaced by additional modules not mentioned here.

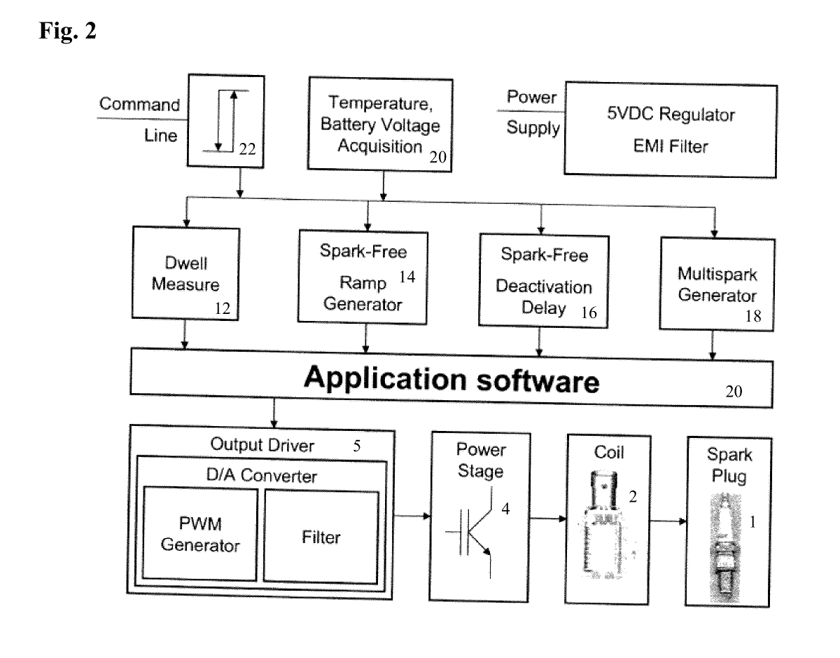

FIG. 2 shows a functional block diagram of a potential embodiment of the system architecture. The figure shows several functional blocks, wherein each of the blocks may be implemented as a hardware block and/or software block as desired. As previously described, the application software 10 of the microcontroller 3 may have several functional blocks. In this example, dwell measure 12, ramp generator 14, deactivation delay 16 and multispark generator 18 modules are shown schematically, which may provide inputs to or may receive outputs from other elements. Not all of these modules need to be present in various embodiments of the system and/or method, dependent on the actual control design. The functional connections and details of output driver stage 5, power stage 4 and coil 2 are as previously described for FIG. 1. Sensors may or may not be present, the measuring values of which may then be fed to the application software or to single functional modules. In the example, temperature and battery voltage acquisition 20 is shown, but other sensors or parameters may be used as well. Also, an input line may be provided that allows for input of signals from the main engine control unit or from other external control units to the smart ignition coil. The input line may be protected against signal noise by suitable filters 6 such as a Schmitt trigger 22.

It will be understood that the described details of embodiments are only given by way of example. Elements may be exchanged and combined between the exemplary embodiments without departing from the general solution described herein, which is based on local ignition coil control via a dedicated controller preferably mounted on the coil. Especially, the skilled person will be aware that elements described in detail with a specific embodiment may in the same way be applied to another embodiment where these details have not been mentioned explicitly, as long as the technical features are compatible with each other.

1. A device comprising
an ignition coil,
a power stage and
a controller connected to said ignition coil via said power stage, wherein the controller is adapted to receive commands and/or parameters related to engine operation and to process said commands and/or parameters, and wherein the controller is further adapted to output a voltage signal to said ignition coil via said power stage, said signal being based at least in part on said processed commands and/or parameters.

2. The device of claim 1, wherein said controller is mounted on said ignition coil.

3. The device of claim 1, further comprising at least one sensor measuring parameters descriptive of operating conditions of said engine, wherein said sensor is adapted to transmit said parameters to said controller.

4. The device of claim 1, further comprising a spark plug, wherein said ignition coil is mounted on said spark plug.

5. The device of claim 1, further comprising a storage module, wherein said storage module is adapted for read and/or write access by said controller.

6. The device of claim 1, further comprising an output driver stage connected between said power stage and said microcontroller.

7. The device of claim 1, comprising at least one functional module.

8. The device of claim 7, wherein the at least one functional module is implemented as a software module on said controller.

9. The device of claim 7, wherein the at least one functional module is implemented at least partially as a hardware module.

10. The device of claim 7, wherein the at least one functional module is one of: a ramp generator, a dwell measure module, a multispark generator, and/or a deactivation delay module.

11. A method for controlling an ignition coil in a combustion engine, comprising receiving parameter values and/or commands related to engine operation at a controller mounted on an ignition coil;
processing at least a part of said parameter values and/or commands;
providing an output signal based on said processing to a power stage driving said ignition coil.

12. The method of claim 11, further comprising
measuring said parameters values by means of at least one sensor in communication with said microcontroller.

13. The method of claim 11, further comprising
adjusting an algorithm stored at said microcontroller in response to one of said received parameter values and/or commands.

14. The method of claim 11, wherein said parameter values are associated to at least one of the following parameters: engine temperature, engine speed, fuel rating, battery voltage, spark frequency, spark duration, combustion parameters.

15. The method of claim 11, wherein said output signal is a pulse width modulated signal.

16. Computer program product comprising program code which, when executed, will perform the method steps of claim 11.
